(19) United States
(12) Patent Application Publication
(10) Pub. No.: US 2019/0354645 A1
(43) Pub. Date: Nov. 21, 2019

(54) METHOD FOR PRESERVING A VIRTUAL OBJECT

(71) Applicant: National Taiwan Normal University, Taipei City (TW)

(72) Inventors: Ming-Yueh HWANG, Taipei City (TW); Jon-Chao HONG, Taipei City (TW); Chi-Ruei TSAI, Taipei City (TW)

(73) Assignee: National Taiwan Normal University, Taipei City (TW)

(21) Appl. No.: 16/134,129

(22) Filed: Sep. 18, 2018

(30) Foreign Application Priority Data
May 17, 2018 (TW) 107116722

(51) Int. Cl. G06F 17/50; H04W 4/021; G06F 17/30; H04W 4/18; G06F 9/54

(52) U.S. Cl. CPC G06F 17/5009; H04W 4/021; G06F 9/542; H04W 4/185; G06F 17/30241

(57) ABSTRACT

A method is provided for preserving a virtual object to be implemented by an electronic device including storage unit that stores actual data sets corresponding respectively to geographical regions, and each including an actual value of a parameter. The method includes steps of: obtaining a current position of the electronic device; acquiring one actual data set corresponding to the geographical region covering the current position; setting a virtual value of the parameter to the actual value of the corresponding actual data set; determining whether the virtual value falls within a range; when negative, determining whether an instruction is received within a time period; and when negative, outputting a notification of failure.

### CROSS-REFERENCE TO RELATED APPLICATION

This application claims priority to Taiwanese Patent Application No. 107116722 filed on May 17, 2018.

### FIELD

The disclosure relates to a method for preserving a virtual object to be implemented by a portable electronic device.

### BACKGROUND

Generally, specimens (e.g., biological specimens) should be preserved under an environment that satisfies certain conditions related to temperature, humidity or illuminance. The specimens would discolor, deteriorate or be molded when disposed in an environment that fails to satisfy the certain conditions for a period of time. It is worth working on the subject of simulating preservation of an object, e.g., preserving a virtual article or breeding a virtual animal, in a virtual environment so that a user can learn some concepts about preservation of the object.

### SUMMARY

Therefore, an object of the present disclosure is to provide a method for preserving a virtual object in a portable electronic device.

According to one aspect of the present disclosure, the method is to be implemented by a portable electronic device. The portable electronic device includes a positioning unit, an input unit, an output unit, a storage unit and a processing unit. The storage unit stores a plurality of actual environmental data sets corresponding respectively to a plurality of geographical regions. Each of the actual environmental data sets includes an actual value of at least one environmental parameter. The method includes steps of:

obtaining, by the positioning unit, a current position of the portable electronic device;

acquiring, by the processing unit, a corresponding one of the actual environmental data sets that corresponds to the geographical region covering the current position of the portable electronic device;

setting, by the processing unit, a virtual value of the environmental parameter of a virtual environment where the virtual object is located to the actual value of the corresponding one of the actual environmental data sets;

determining, by the processing unit, whether the virtual value falls within a predetermined range of the environmental parameter associated with conditions for preserving the virtual object;

when it is determined that the virtual value does not fall within the predetermined range, determining, by the processing unit, whether an instruction for setting the virtual value of the environmental parameter of the virtual environment to fall within the predetermined range is received within a predetermined time period from the input unit; and

when it is determined that the instruction is not received within the predetermined time period, controlling, by the processing unit, the output unit to output a notification indicating that preservation of the virtual object has failed.

### BRIEF DESCRIPTION OF THE DRAWINGS

Other features and advantages of the present disclosure will become apparent in the following detailed description of the embodiments with reference to the accompanying drawings, of which:

FIG. 1 is a schematic block diagram of a portable electronic device for implementing a method for preserving a virtual object according to one embodiment of the present disclosure; and

FIG. 2 illustrates a flow chart of the method for preserving a virtual object according to one embodiment of the present disclosure.

### DETAILED DESCRIPTION

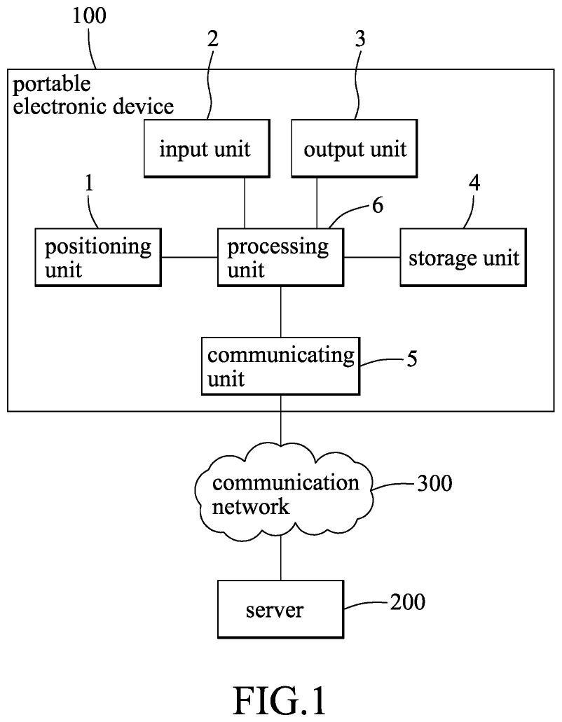

Referring to FIG. 1, a portable electronic device 100 for implementing a method for preserving a virtual object is shown. The portable electronic device 100 includes a positioning unit 1, an input unit 2, an output unit 3, a storage unit 4, a communicating unit 5 and a processing unit 6. The positioning unit 1 is, for example, a global positioning system (GPS) module, and is to obtain a current position of the portable electronic device 100, for example, according to data from at least three GPS satellites. The input unit 2 and the output unit 3 are integrated as a touchscreen, for example. The storage unit 4 is, for example, flash memory, and stores a plurality of actual environmental data sets corresponding respectively to a plurality of geographical regions. Each of the actual environmental data sets includes multiple actual values respectively of multiple environmental parameters at the corresponding one of the geographical regions. For example, the environmental parameters are temperature, humidity and illuminance, respectively. The portable electronic device 100 is communicatively connected to a server 200 by the communicating unit 5 via a communication network 300. The communicating unit 5 may for example be implemented using 4G technology (fourth generation of broadband cellular network technology). The server 200 stores a plurality of real-time environmental data sets corresponding respectively to the geographical regions. Each of the real-time environmental data sets includes multiple real-time values respectively of the environmental parameters. In one embodiment, the server 200 is hosted by a central weather bureau of a country that measures the real-time values of the environmental parameters at all times.

The processing unit 6 transmits a request to the server 200 via the communicating unit 5 to request for the real-time environmental data sets, for example, every twenty-four hours, and updates the actual environmental data sets with the real-time environmental sets upon receipt of the same. The term “processing unit” may refer to any device or portion of a device that processes electronic data from registers and/or memory to transform that electronic data into other electronic data. For example, in other embodiments, the processing unit 6 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. The portable electronic device 100 may be implemented by a smartphone in one instance of this disclosure.

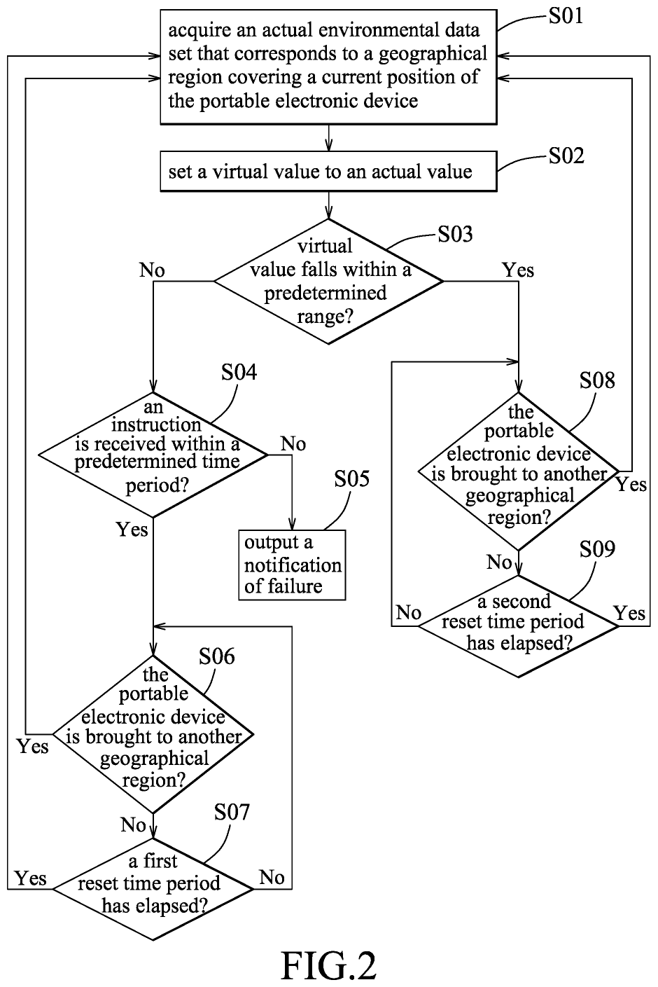

Further referring to FIG. 2, the method for preserving a virtual object implemented by the portable electronic device 100 will be described in the following. The virtual object can be one of a virtual antique, a virtual specimen, a virtual stamp, a virtual goldfish, etc. to be preserved in a virtual environment, but the present disclosure is not limited in this respect. It should be noted that the term “preserve” as used herein means preserving or maintaining a virtual article (e.g., the virtual antique, the virtual specimen, the virtual stamp, etc.) or breeding or keeping alive a virtual animal (e.g., the virtual goldfish).

When performing the method for preserving a virtual object, the communicating unit 5 periodically sends the request for the real-time environmental data sets to the server 200 as controlled by the processing unit 6 to obtain the real-time environmental data sets, and then the processing unit 6 updates the actual environmental data sets stored in the storage unit 4 with the real-time environmental data sets thus obtained.

After the positioning unit 1 obtains a current position of the portable electronic device 100, the processing unit 6 acquires from the storage unit 4, in step S01, a corresponding one of the actual environmental data sets that corresponds to the geographical region covering the current position of the portable electronic device 100.

In step S02, the processing unit 6 sets multiple virtual values respectively of the environmental parameters of a virtual environment where the virtual object is located respectively to the actual values of the corresponding one of the actual environmental data sets. Specifically, the virtual values of the environmental parameters of the virtual environment are, for example, a virtual temperature value, a virtual humidity value and a virtual illuminance value, and are set to be equal respectively to the actual values of the actual environmental data set corresponding to the geographical region where the portable electronic device 100 is currently physically located.

In step S03, for each of the virtual values, the processing unit 6 determines whether the virtual value falls within a corresponding predetermined range of the respective environmental parameter associated with conditions for preserving the virtual object. For example, in a case that the virtual object to be preserved is a virtual goldfish, the predetermined range for the environmental parameter of temperature may be 20° C. to 28° C.

When it is determined that any one of the virtual values does not fall within the corresponding predetermined range, step S04 is performed. In step S04, the processing unit 6 determines whether an instruction for setting the virtual value of one of the environmental parameters of the virtual environment (referred to as anon-compliant environmental parameter hereinafter) to fall within the corresponding predetermined range is received within a predetermined time period from the input unit 2. That is to say, the processing unit 6 determines whether the portable electronic device 100 is operated, for example, by a user thereof using the input unit 2 to generate the instruction within the predetermined time period. In one embodiment, the predetermined time period is two hours but the present disclosure is not limited in this respect.

When the determination made in step S04 is negative, the flow of the method goes to step S05; otherwise, the flow of the method goes to step S06. In step S05, the processing unit 6 controls the output unit 3 to output a notification indicating that preservation of the virtual object has failed. When the user does not timely input the instruction for setting the virtual value of the non-compliant environmental parameter to fall within the corresponding predetermined range, preservation of the virtual object fails. For example, the touchscreen of the portable electronic device 100 displays a notification of “Failed” to notify the user that the preservation of the virtual object has failed. It should be noted that the failure in preserving the virtual object means that the virtual article is damaged or the virtual animal is sick or dead.

In step S06, the processing unit 6 determines whether the portable electronic device 100 is brought to another one of the geographical regions according to an updated position of the portable electronic device 100 that is newly and currently obtained by the positioning unit 1. When the determination made in step S06 is affirmative, steps of the method are performed again with the updated position serving as the current position.

When the determination made in step S06 is negative, step S07 is performed. In step S07, the processing unit 6 determines whether a first reset time period has elapsed after the processing unit 6 received the instruction (step S04) for setting the virtual value of the non-compliant environmental parameter of the virtual environment to fall within the corresponding predetermined range. In one embodiment, the first reset time period is twenty-four hours. When the determination made in step S07 is affirmative, steps of the method are performed again; otherwise, the flow of the method goes back to step S06. That is to say, when it is determined that the portable electronic device 100 is not brought to another one of the geographical regions within the first reset time period, an effect of the instruction for setting the virtual value of the non-compliant environmental parameter becomes invalid, the virtual value of the non-compliant environmental parameter that was set to fall within the corresponding predetermined range would be out of the predetermined range again, and the flow of the method goes back to step S01. On the other hand, when it is determined that the portable electronic device 100 is brought to another one of the geographical regions within the first reset time period, the effect of the instruction for setting the virtual value of the non-compliant environmental parameter also becomes invalid, and the virtual value of the non-compliant environmental parameter is updated to the actual value included in one of the actual environmental data sets that corresponds to said another one of the geographical regions covering the updated position of the portable electronic device 100. Note that once the effect of the instruction for setting the virtual value of the non-compliant environmental parameter to fall within the corresponding predetermined range becomes invalid, the user should pay attention to whether to input the instruction again for setting the virtual value of any environmental parameter to fall within the corresponding predetermined range so as to prevent failure in preserving the virtual object.

When it is determined that all of the virtual values fall respectively within the corresponding predetermined ranges (i.e., the determination made in step S03 is affirmative), step S08 is performed. In step S08, the processing unit 6 determines whether the portable electronic device 100 is brought to another one of the geographical regions according to an updated position of the portable electronic device 100 that is newly and currently obtained by the positioning unit 1. When the determination made in step S08 is affirmative, steps of the method are performed again with the updated position serving as the current position; otherwise, the flow of the method goes to step S09. In step S09, the processing unit 6 determines whether a second reset time period has elapsed after step S03 is implemented. For example, the second reset time period is twenty-four hours, but the present disclosure is not limited in this respect. When the determination made in step S09 is affirmative, steps of the method are performed again; otherwise, the flow of the method goes back to step S08.

For example, in one of the actual environmental data sets corresponding to one of the geographical regions (A), the actual values of three environmental parameters of temperature, humidity and illuminance are respectively 35° C., 75% and 500 lux; in another one of the actual environmental data sets corresponding to another one of the geographical regions (B), the actual values of the three environmental parameters are respectively 32° C., 70% and 400 lux; the predetermined ranges of the three environmental parameters associated with conditions for preserving a virtual object are, for example, 16-24° C., 45-63% and 0-300 lux, respectively. Given the above, when a current position of the portable electronic device 100 is covered by the geographical region (A), the virtual values are all out of the respective predetermined ranges, and the user should operate the input unit 2 within the predetermined time period (e.g., two hours) to input the instruction for setting the virtual values of the environmental parameters to fall within the respective predetermined ranges, for example, to 20° C., 50% and 50 lux, or otherwise the preservation for the virtual object would fail. When the portable electronic device 100 is brought from the geographical region (A) to the geographical region (B), the instruction should be received again within the predetermined time period. The instruction for setting the virtual values of the three environmental parameters becomes invalid if the portable electronic device 100 remains in the geographical region (A) for twenty-four hours, and the user should pay attention to whether to input the instruction for setting the virtual values to fall within the predetermined ranges again.

To sum up, the method according to the embodiments of the present disclosure is a location-based service (LBS) that is to obtain a current position of the portable electronic device 100 and to set the virtual values of the environmental parameters of the virtual environment to the actual values of the environmental parameters that are updated periodically. Further, the processing unit 6 controls the output unit 3 to output a notification to indicate failure of the preservation of the virtual object when the processing unit 6 determines that the instruction for setting the virtual values to fall within the predetermined ranges is not received within certain time period. In this way, the user can learn how to preserve an object in the real world from participating in simulated preservation of the object such as a specimen by a portable electronic device.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for preserving a virtual object, the method to be implemented by a portable electronic device including a positioning unit, an input unit, an output unit, a storage unit and a processing unit, the storage unit storing a plurality of actual environmental data sets corresponding respectively to a plurality of geographical regions, each of the actual environmental data sets including an actual value of at least one environmental parameter, the method comprising steps of:
obtaining, by the positioning unit, a current position of the portable electronic device;
acquiring, by the processing unit, a corresponding one of the actual environmental data sets that corresponds to the geographical region covering the current position of the portable electronic device;
setting, by the processing unit, a virtual value of the environmental parameter of a virtual environment where the virtual object is located to the actual value of the corresponding one of the actual environmental data sets;
determining, by the processing unit, whether the virtual value falls within a predetermined range of the environmental parameter associated with conditions for preserving the virtual object;
when it is determined that the virtual value does not fall within the predetermined range, determining, by the processing unit, whether an instruction for setting the virtual value of the environmental parameter of the virtual environment to fall within the predetermined range is received within a predetermined time period from the input unit; and
when it is determined that the instruction is not received within the predetermined time period, controlling, by the processing unit, the output unit to output a notification indicating that preservation of the virtual object has failed.

2. The method as claimed in claim 1, further comprising steps of:
when it is determined that the instruction is received within the predetermined time period, determining, by the processing unit, whether the portable electronic device is brought to another one of the geographical regions according to an updated position of the portable electronic device that is newly and currently obtained by the positioning unit; and
when it is determined that the portable electronic device is brought to another one of the geographical regions, repeating the steps of the method.

3. The method as claimed in claim 2, further comprising steps of:
when it is determined that the electronic device is not brought to another one of the geographical regions, determining, by the processing unit, whether a reset time period has elapsed after the processing unit received the instruction;
when it is determined that the reset time period has not elapsed, repeating the step of determining whether the portable electronic device is brought to another one of the geographical regions according to an updated position of the portable electronic device that is currently obtained by the positioning unit; and
when it is determined that the reset time period has elapsed, repeating the steps of the method.

4. The method as claimed in claim 1, further comprising steps of:
when it is determined that the virtual value falls within the predetermined range of the environmental parameter, determining, by the processing unit, whether the portable electronic device is brought to another one of the geographical regions according to an updated position of the portable electronic device that is newly and currently obtained by the positioning unit;
when it is determined that the portable electronic device is brought to another one of the geographical regions, repeating the steps of the method with the updated position serving as the current position.

5. The method as claimed in claim 4, further comprising:
when it is determined that the portable electronic device is not brought to another one of the geographical regions, determining, by the processing unit, whether a reset time period has elapsed after the processing unit received the instruction;
when it is determined that the reset time period has not elapsed, repeating the step of determining whether the portable electronic device is brought to another one of the geographical regions according to an updated position of the portable electronic device that is currently obtained by the positioning unit; and
when it is determined that the reset time period has elapsed, repeating the steps of the method with the updated position serving as the current position.

6. The method as claimed in claim 1, the portable electronic device further including a communicating unit communicating with a server that stores a plurality of real-time environmental data sets corresponding respectively to the geographical regions, each of the real-time environmental data sets including a real-time value of the environmental parameter, the method further comprising steps of:
periodically sending, by the communicating unit to the server, a request for the real-time environmental data sets, as controlled by the processing unit; and
updating, by the processing unit, the actual environmental data sets with the real-time environmental data sets.
